(19) United States
(12) Patent Application Publication
(10) Pub. No.: US 2026/0268845 A1
(43) Pub. Date: Sep. 10, 2026

(54) PIXEL DRIVING CIRCUIT AND DISPLAY PANEL

(71) Applicant: Wuhan China Star Optoelectronics Semiconductor Display Technology Co., Ltd., Wuhan, Hubei (CN)

(72) Inventor: Huanxi ZHANG, Wuhan, Hubei (CN)

(21) Appl. No.: 18/579,383

(22) PCT Filed: Dec. 11, 2023
(86) PCT No.: PCT/CN2023/137781

§ 371 Date: Jan. 15, 2024

(30) Foreign Application Priority Data
Nov. 30, 2023 (CN) 202311641913.7

(51) Int. Cl. G09G 3/3233

(52) U.S. Cl. CPC G09G 3/3233; G09G 2300/043; G09G 2300/0819; G09G 2300/0842; G09G 2310/08; G09G 2320/045; G09G 2330/021

(57) ABSTRACT

A pixel driving circuit and a display panel are provided. The pixel driving circuit includes a driving transistor, a data writing transistor for responding to a second writing control signal to transmit a data signal to the driving transistor, an internal compensation transistor for responding to a first writing control signal to compensate a threshold voltage of the driving transistor, and an external compensation transistor electrically to a light-emitting control transistor and a source of the driving transistor. The first writing control signal is different from the second writing control signal.

### TECHNICAL FIELD

The present disclosure relates to the display technology field, and more particularly to a pixel driving circuit and a display panel.

### BACKGROUND ART

OLED (Organic Light-Emitting Diode) display panels are widely used due to their flexibility and other characteristics.

In order to realize functions of a display panel at different periods of time and to improve reliability of operations of the display panel, a pixel driving circuit of an OLED display panel has high requirements on timing design.

### SUMMARY OF DISCLOSURE

The disclosure provides a display panel capable of alleviate the technical problem that the current microlens structure has limited improvement in the light extraction efficiency of the display panel and that it is difficult to significantly improve the light extraction efficiency of the display panel.

The present disclosure provides a pixel driving circuit and a display panel to improve a functional reliability of the display panel at different times.

The present disclosure a pixel driving circuit including:
a light-emitting element;
a driving transistor for generating a driving current according to a data signal to drive the light-emitting element to emit light;
a data writing transistor for transmitting the data signal to the driving transistor in response to a second write control signal;
a storage capacitor electrically connected to the driving transistor for storing the data signal;
an internal compensation transistor electrically connected between a gate of the driving transistor and a drain of the driving transistor for compensating a threshold voltage of the driving transistor in response to a first writing control signal, wherein the first writing control signal is different from the second writing control signal; and

### ADVANTAGEOUS EFFECTS

[symbol] an external compensation transistor, wherein the external compensation transistor is electrically connected to the light-emitting control transistor and a source of the driving transistor, and the external compensation transistor is used for responding to a reading and writing control signal to read an electrical signal of the source of the driving transistor and to compensate the threshold voltage of the driving transistor.

The present disclosure provides the pixel driving circuit and the display panel based on the light-emitting element, the driving transistor for generating the driving current according to the data signal to drive the light-emitting element to emit light, the storage capacitor for storing the data signal, the internal compensation transistor for responding to the first writing control signal to compensate the threshold voltage of the driving transistor, and the external compensation transistor for reading the electrical signal from the source of the drive transistor in response to the reading and writing control signal and compensating the threshold voltage of the driving transistor (electrically connected to the source of the light-emitting control transistor and the driving transistor). The first writing control signal is set to be different from the second writing control signal, so that in the data writing period of each frame, the data signal is transmitted to one end of the storage capacitor to turn on the driving transistor. The gate and the drain of the driving transistor are electrically disconnected, thereby improving the reliability of data signal writing and the accuracy of driving current.

### BRIEF DESCRIPTION OF DRAWINGS

In order to illustrate the technical solutions related to the embodiments of the present disclosure more clearly, a brief description of the drawings referred to in the description of various embodiments is provided below. Obviously, drawings described below illustrate only some embodiments of the present disclosure. It should be apparent to those having ordinary skill in the art to derive other drawings from these accompanying drawings without creative efforts.

FIG. 1 illustrates a schematic structural diagram of a display panel provided by an embodiment of the present disclosure.

FIG. 2 illustrates a schematic structural diagram of a pixel driving circuit provided by an embodiment of the present disclosure.

FIG. 3, FIG. 5, FIG. 8, FIG. 10, and FIG. 12 respectively illustrate waveform diagrams of some signals in the pixel driving circuit provided by embodiments of the present disclosure.

FIG. 4, FIG. 7, FIG. 9, FIG. 11, and FIG. 13 to FIG. 18 respectively illustrate schematic diagrams of a signal flow in some stages of the pixel driving circuit provided by an embodiment of the present disclosure.

FIG. 6 illustrates a variation curve of a potential VB of a third node B at t1 in the pixel driving circuit.

### EMBODIMENTS OF DISCLOSURE

The following clearly describes the technical solutions in the embodiments of the disclosure with reference to the accompanying drawings. Obviously, the embodiments described are only some of the embodiments of the present disclosure instead of all of them. All other embodiments obtained by those of ordinary skills in the art based on the embodiments herein without any creative efforts are within the scope of the present disclosure.

In the description of the present disclosure, terms such as “first” and “second” are used herein for purposes of description and are not intended to indicate or imply relative importance or significance. Thus, features limited by “first” and “second” are intended to indicate or imply including one or more than one these features. In the present disclosure, a source and a drain of a transistor are not distinguished. The two can be exchanged. Furthermore, it should be noted that the drawings only provide structures that are closely related to the present disclosure, and some details that are not closely related to the present disclosure are omitted. The purpose is to simplify the drawings and make the present disclosure points clear at a glance, rather than to indicate that an actual device is exactly the same as the drawings and does not serve as a limitation of the actual device.

Reference herein to “an embodiment” means that a particular feature, structure or characteristic described in connection with the embodiment can be included in at least one embodiment of the present disclosure. The appearances of the phrase at various places in the specification are not necessarily all referring to the same embodiment, nor are separate or alternative embodiments mutually exclusive of other embodiments. Those skilled in the art understand, both explicitly and implicitly, that the embodiments described herein can be combined with other embodiments.

In the present disclosure, a pixel driving circuit and a display panel including the pixel circuit are provided. The display panel and the pixel driving circuit include but are not limited to the following embodiments and combinations of the following embodiments.

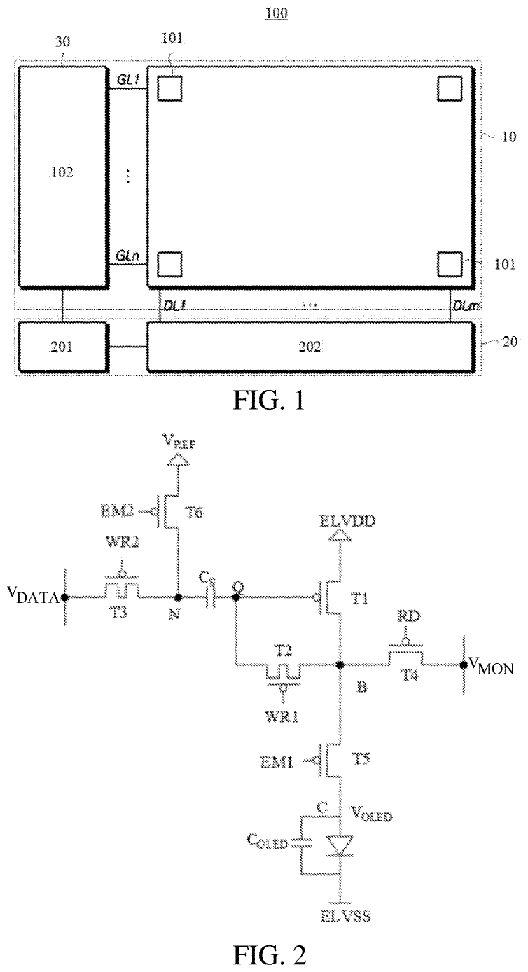

In some embodiments, as shown in FIG. 1, the display panel 100 a panel body 10 includes a pixel driving circuit 101 as described below; and a driving chip 20 electrically connected to the pixel driving circuit 101 to drive the pixel driving circuit 101 to operate. It can be understood that the driving chip 20 stores a plurality of instructions and a plurality of data. The plurality of instructions can control transmission of the plurality of data to control the driving chip 20 internally and communication between the driving chip 20 and the panel body 10, thereby achieving display of an image.

Specifically, as shown in FIG. 1, the panel body 10 further includes multi-level gate driving circuits arranged in cascade (included in a gate driving module 102). The driving chip 20 includes a timing controller 201. Each of the gate driving circuits is electrically connected between the timing controller 201 and a corresponding one of plurality of pixel driving circuits 101 for responding to a first control signal outputted by the timing controller to output a gate signal (including a first light-emitting control signal EM1, a second light-emitting control signal EM2, a first writing control signal WR1, or a second writing control signal WR2 below). At least one source driver 202 is electrically connected between the timing controller 201 and the corresponding plurality of pixel driving circuits 101 for responding to a second control signal outputted by the timing controller to output a data signal VDATA.

For the convenience of description, an array of multiple pixel driving circuits 101 arranged in n rows and m columns (both n and m are positive integers) is used as an example. The gate driving module 102 can include at least n-level gate driving circuits. As shown in FIG. 1, each of the gate driving circuits outputs a corresponding gate signal according to the first control signal. N-level gate signals are respectively transmitted to the pixel driving circuits 101 in the n-row pixels through n gate lines (GL1 to GLn). The first control signal controls the gate driving module 102 so that effective gate pulses used to turn on the pixel driving circuits 101 in the n-level gate signals can be arranged sequentially in a time axis to turn on the multiple rows of pixel driving circuits 101 in sequence. The source driver 202 can respectively transmit multiple sets of data signals VDATA to the pixel driving circuits 101 in the multiple columns through m data lines (DL1 to DLm). Each set of the data signals VDATA can include a plurality of data signals VDATA corresponding to a plurality of pixel driving circuits 101 in the same column. When the second control signal controls the source driver 202 to turn on the pixel driving circuits 101 in each row, the multiple data lines respectively receive multiple data voltages from the multiple pixel driving circuits 101 also located in the row, thereby causing the multiple data voltages act on the multiple pixel driving circuits 101 in the row to realize emission of light by multiple light-emitting elements in the multiple pixel driving circuits 101 in the row. By analogy, the emission of all rows of light-emitting elements can be controlled in sequence to present a complete image.

In some embodiments, as shown in FIG. 2, the pixel driving circuit 101 includes a light-emitting element (the light-emitting element includes a light-emitting element body and a light-emitting element capacitor Coled connected in parallel with it, and the subsequent and referred to emission can be referred to understood as emitting light from “the light-emitting element body”). A driving transistor T1 is used for generating a driving current according to one of the data signals VDATA to drive the light-emitting element to emit light. A data writing transistor T3 is used for responding to the second writing control signal WR2 to transmit the one of the data signals VDATA to the driving transistor T1. A storage capacitor Cs electrically connected to the driving transistor T1 is used for storing the one of the data signals VDATA. An internal compensation transistor T2 electrically connected between a gate of the driving transistor T1 and a drain of the driving transistor T1 is used for compensating a threshold voltage of the driving transistor T1 in response to the first writing control signal WR1.

Further, as shown in FIG. 2, the pixel driving circuit 101 also includes an external compensation transistor T4. The external compensation transistor T4 is electrically connected to a light-emitting control transistor T5 and a source of a driving transistor T1. The external compensation transistor T4 is used for reading an electrical signal of a source of the driving transistor T1 in response to a reading and writing control signal RD and for compensating the threshold voltage of the driving transistor T1. Specifically, a gate of the external compensation transistor T4 is loaded with the reading and writing control signal RD, a source of external compensation transistor T4 can be connected to the drain of driving transistor T1, and a drain of the external compensation transistor T4 can be loaded with a fourth signal VMON.

When the driving transistor T1 is in an off state, a potential of the source of the driving transistor T1 is detected, the drain of the external compensation transistor T4 can be connected to an external compensation module. The external compensation module can calculate the threshold voltage of the driving transistor T1 by measuring the potential of the source of the driving transistor T1 and a second signal ELVDD loaded on the source of the driving transistor T1, and can calculate a corresponding compensation value to reaction to the pixel driving circuit 101 to compensate the threshold voltage of the driving transistor T1.

The light-emitting element can be an electroluminescent element. The electroluminescent element includes at least one of an OLED and an LED (Light-Emitting Diode). Multiple transistors in the pixel driving circuit 101 can be of the same or different types. For example, they can all be P-type transistors (a material of which can be but not limited to LTPS (Low Temperature Poly-Silicon)), or they can all be N-type transistors (a material of which can be but not limited to IGZO (Indium Gallium Zinc Oxide)). Alternatively, part (for example, including the driving transistor T1 and the light-emitting control transistor T5) is a P-type transistor, and the other part (for example, including the internal compensation transistor T2, the data writing transistor T3, the external compensation transistor T4 and the reset transistor T6) are N-type transistors. It should be noted that the type of each transistor in the present disclosure is not limited. It is intended to illustrate that it has a corresponding function, and a signal acting on the transistor can be set according to its type and functional requirements.

Further, as shown in FIG. 2, the pixel driving circuit 101 also includes the light-emitting control transistor T5 electrically connected between the light-emitting element and the driving transistor T1 for responding to the first light-emitting control signal EM1 to respond to the first light-emitting control signal EM1 to transmit the driving current to the light-emitting element. The reset transistor T6 is electrically connected to the storage capacitor Cs and the data writing transistor T3 and is used for responding to the second light-emitting control signal EM2 to transmit a first signal VREF to one end of the storage capacitor Cs. The first signal VREF is different from the second signal ELVDD loaded on the source of the driving transistor T1.

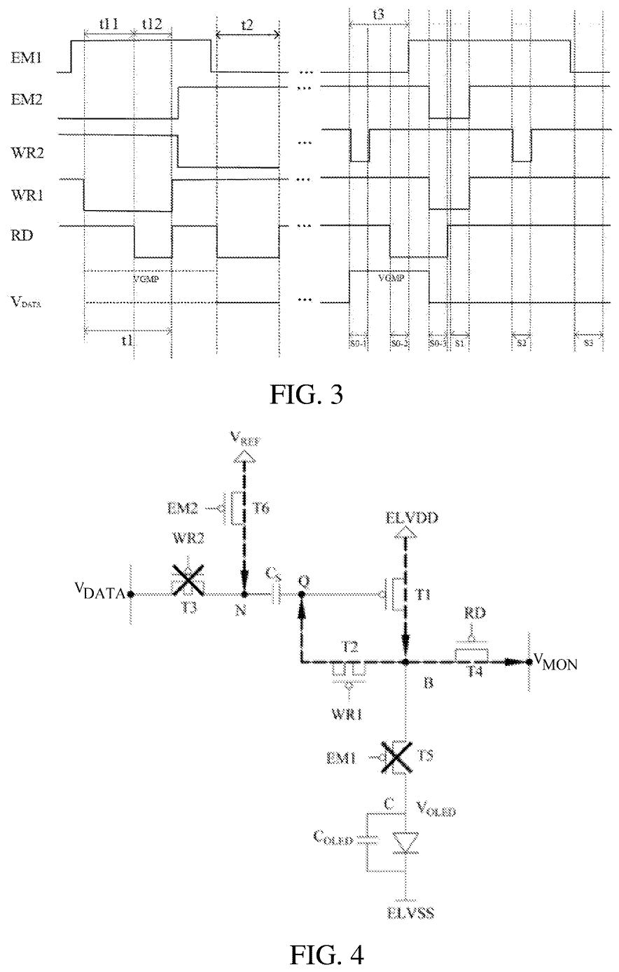

As shown in FIG. 3, the pixel driving circuit 101 has a data writing period S2 in each frame. During the data writing period S2, the first writing control signal WR1 and the second writing control signal WR2 are different. During the data writing period S2, the data writing transistor T3 is used for responding to the second writing control signal WR2 to transmit the data signal VDATA to one end of the storage capacitor Cs to turn on the driving transistor T1. The internal compensation transistor T2 is used for responding to the first writing control signal WR1 to electrically disconnect the gate of the driving transistor T1 and the drain of the driving transistor T1.

Specifically, as shown in FIG. 2, a source of the data writing transistor T3 can be loaded with the data signal VDATA. A source of the reset transistor T6 can be loaded with the first signal VREF. A gate of the data writing transistor T3 is loaded with the second writing control signal WR2. A gate of the reset transistor T6 is loaded with the second light-emitting control signal EM2. A drain of the data writing transistor T3 and a drain of the reset transistor T6 can be connected to a first end of the storage capacitor Cs through a first node N. The gate of the driving transistor T1 and a drain of the internal compensation transistor T2 can be connected to a second end of the storage capacitor Cs through a second node Q. A gate of the internal compensation transistor T2 is loaded with the first writing control signal WR1. The second signal ELVDD loaded on the source of the driving transistor T1. A gate of the light-emitting control transistor T5 is loaded with the first light-emitting control signal EM1. A source of the light-emitting control transistor T5 is connected to the drain of the driving transistor T1 and a source of the internal compensation transistor T2 through a third node B. A drain of the light-emitting control transistor T5 can be connected to an anode of the light-emitting element. A cathode of the light-emitting element can be grounded (i.e., a ground voltage ELVSS is loaded).

The reset transistor T6 can be used for resetting a potential VN of the first node N. Data write transistor T3 can be used for transferring the data signal VDATA to the storage capacitor Cs. The internal compensation transistor T2 can be used for storing the threshold voltage of drive transistor T1 in storage capacitor Cs. The driving transistor T1 can generate the driving current under the action of the data signal VDATA. The light-emitting control transistor T5 is used for turning on the driving current to the light-emitting element to control the light-emitting element to emit light.

In order to better illustrate the above-mentioned functions of the pixel driving circuit 101 of the present disclosure, it is assumed herein that all of the transistors in the pixel driving circuit 101 are P-type transistors (it can be considered that when the signal loaded on the gate is at a corresponding low potential, it can be used for controlling its opening and a corresponding high potential is used for controlling its closing; the high potentials of multiple signals can be equal or unequal, and the low potentials of multiple signals can be equal or unequal). Values of the first signal VREF, the second signal ELVDD, a third signal VGMP, and the fourth signal VMON can also be represented by VREF, ELVDD, VGMP, and VMON respectively, and VREF, ELVDD, and VGMP are high potentials (used for controlling the P-type transistors are turned off) and VMON is at low potential (used to control the P-type transistor to turn on). As an example, a working period of the pixel driving circuit 101 is explained as follows.

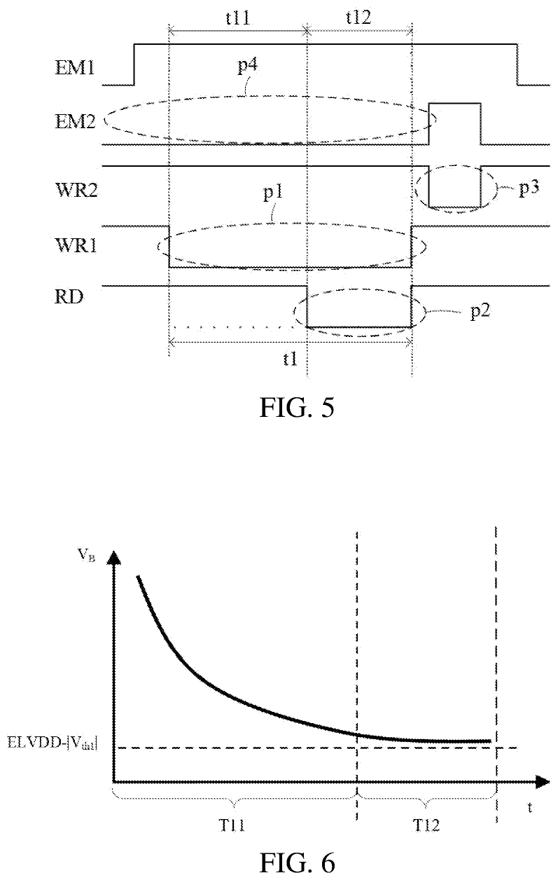

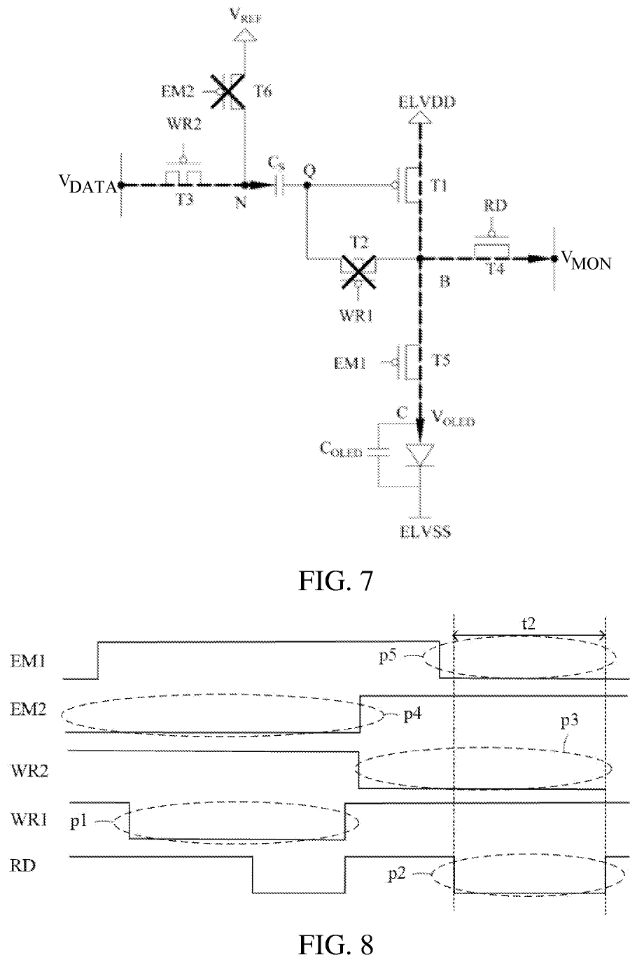

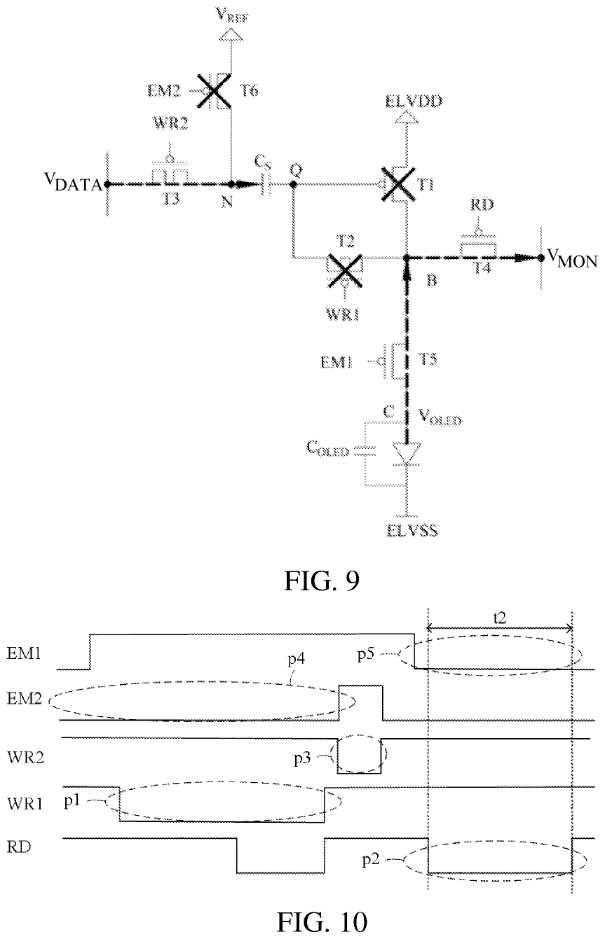

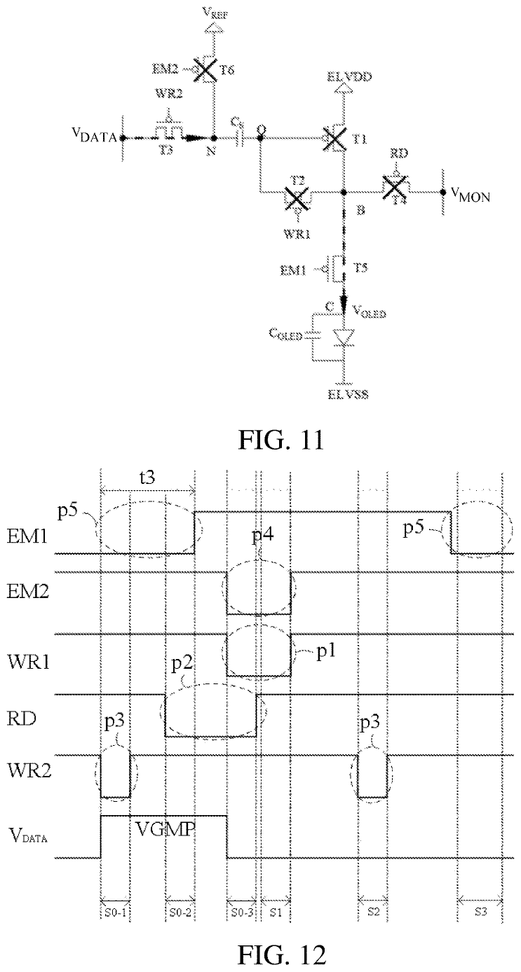

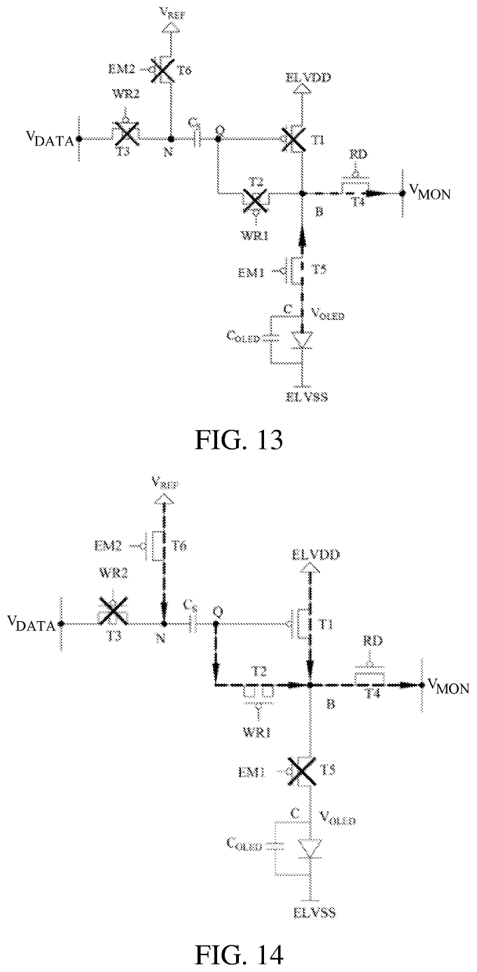

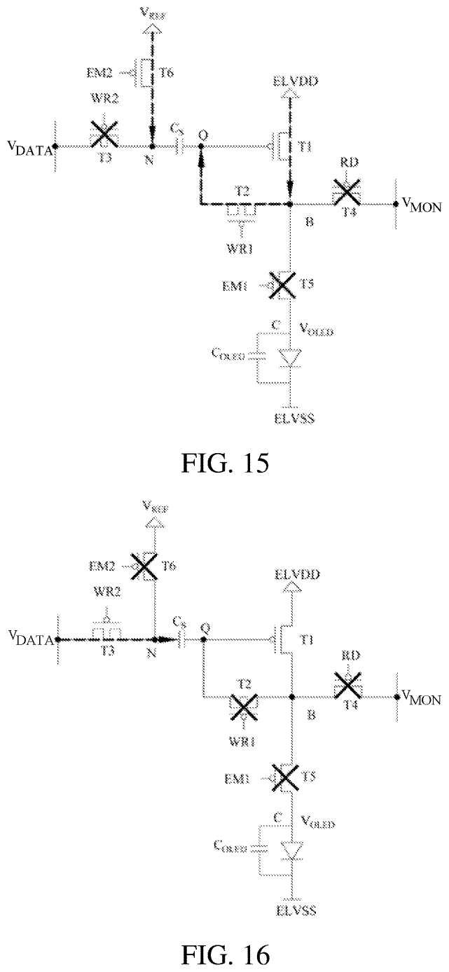

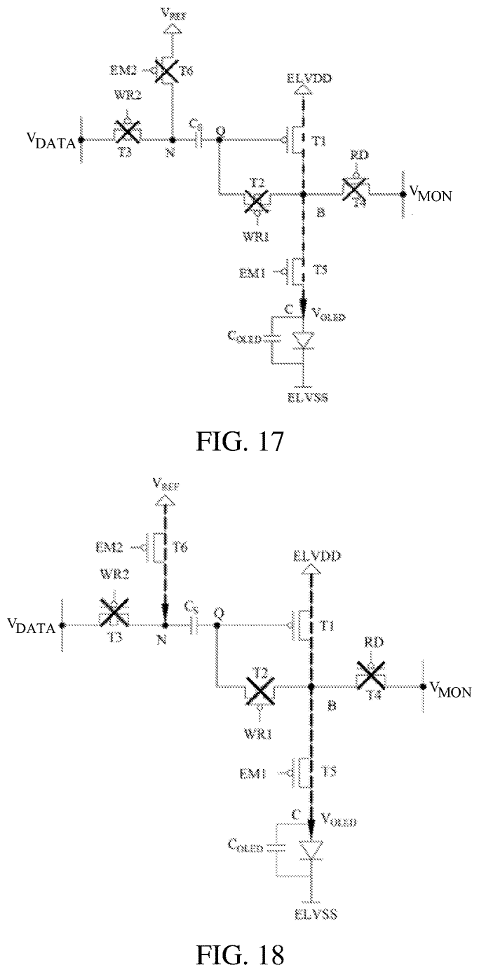

First, in a threshold voltage external detection period t1, as shown in FIG. 4 and FIG. 5, the first light-emitting control signal EM1 and the second writing control signal WR2 are both at corresponding high potentials to control the light-emitting control transistor T5 and the data writing transistor T3 to be turned off. The first writing control signal WR1, the second light-emitting control signal EM2, and the reading and writing control signal RD are all at corresponding low levels to control the internal compensation transistor T2, the reset transistor T6, and the external compensation transistor T4 to be turned on. The first signal VREF is transmitted to the first node N through the reset transistor T6 to maintain the potential VN of the first node N. The second node Q can be reset to a low potential before (for example, the internal compensation transistor T2 and the external compensation transistor T4 can be turned on to transmit the low-potential fourth signal VMON to the second node Q), so the driving transistor T1 can be considered is turned on. The potential VQ of the second node Q gradually rises until the difference between it and the potential of the source of the driving transistor T1 (equal to ELVDD) is equal to the first threshold voltage Vth1 of the driving transistor T1, that is, “VQ−ELVDD=Vth1”. The driving transistor T1 is turned off, so the potential VQ of the second node Q can gradually approach ELVDD+Vth1 (Vth1<0) from its initial potential (which can be close to VMON). As shown in FIG. 6, a change curve of a potential VB of the third node B during this period can be represented. Since the internal compensation transistor T2 is turned on, the external compensation module can obtain the VB, that is VQ, through the external compensation transistor T4.

Further, the threshold voltage external detection period t1 can be divided into a first sub-period t11 and a second sub-period t12 located after the first sub-period t11. As shown in FIG. 6, the first sub-period t11 can be understood as a period in which VQ changes greatly. At this time, the driving transistor T1 is still far away from reaching the cut-off state. The second sub-period t12 is understood to be a period when VQ is relatively stable (close to ELVDD−|Vth1|), so the first writing control signal WR1 needs to be sufficient for the duration corresponding to the low potential (unknown, which can be set based on multiple experimental values or experience values) long to ensure that the second sub-period t12 can be reached. In order to reduce power consumption of the external compensation module to detect Vth1, the reading and writing control signal RD can be set to the corresponding low level only in the second sub-period t12 to turn on the external compensation transistor T4 to make the external compensation module work.

It can be seen that a first writing control pulse p1 in the first writing control signal WR1 overlaps with a reading and writing control pulse p2 in the reading and writing control signal RD, and a starting point of the first writing control pulse p1 is earlier than a starting point of the corresponding reading and writing control pulse p2. For example, as shown in FIG. 5, during the threshold voltage external detection period t1, the first writing control pulse p1 can cover the first sub-period t11, but the reading and writing control pulse p2 can only cover the second sub-period t12.

Specifically, the pixel driving circuit 101 has the above-mentioned threshold voltage external detection period t1 before a first frame (which can be understood as the first frame displayed after the display panel 100 is turned on). In conjunction with the above-mentioned discussion, during the threshold voltage external detection period t1, the first light-emitting control signal EM1 is different from the first writing control signal WR1. The specific performance is as described as follows. The reset transistor T6 is used for transmitting the first signal VREF to the one end of the storage capacitor Cs in response to the second light-emitting control signal EM2, and the data writing transistor T3 is used for responding to the second writing control signal WR2 to transmit the third signal VGMP to the one end of the storage capacitor Cs in respect to the second writing control signal WR2. At least one of two functions is implemented. The internal compensation transistor T2 is used for transmitting the second signal ELVDD to the one end of the storage capacitor Cs in response to the first writing control signal WR1. The external compensation transistor T4 is used for responding to the reading and writing control signal RD to read the threshold voltage of the driving transistor T1 (the above-mentioned first threshold voltage Vth1). The light-emitting control transistor T5 is used for responding to the first light-emitting control signal EM1 to electrically disconnect from the driving transistor T1.

It can be understood that in an example in FIG. 4 and FIG. only the reset transistor T6 is responding to the second light-emitting control signal EM2 to transmit the first signal VREF to the one end of the storage capacitor Cs (the first node N, that is, the first end of the storage capacitor Cs). A function is to maintain the potential of the first terminal of the storage capacitor Cs, so that the storage capacitor Cs can be charged stably. Similarly, a method in FIGS. 4 and 5 can be replaced by setting the second writing control signal WR2 to a corresponding low level to transmit the third signal VGMP to the first end of the storage capacitor Cs.

Therefore, during the period, any one of the second writing control signal WR2 and the second light-emitting control signal EM2 can be set to the corresponding low potential. What should be satisfied is that the first light-emitting control signal EM1 is different from the first writing control signal WR1. For example, a former is set to the corresponding high potential to turn off the light-emitting control transistor T5 to prevent the light-emitting element from emitting light, and a latter is set to the corresponding low potential to turn on the internal compensation transistor T2 to charge the second node Q.

Specifically, the threshold voltage external detection period t1 after an i1-th time (i4 is a positive integer) can be detected through the above-mentioned method to obtain the i1+th VQ (called VQ1, close to ELVDD−|Vth1|). During the threshold voltage external detection period t1 after power-on for an i2-th time (i2 is a positive integer greater than i1), the i2+th VQ (called VQ2, close to ELVDD−|Vth2|) is detected through the above-mentioned method. A Vth2 is the threshold voltage of the driving transistor T1 when the power is turned on for the i2-th time, which is called the second threshold voltage Vth2. Compared with the i1-th time of power-on, an absolute value of an offset ΔVth of the threshold voltage of the driving transistor T1 is approximately equal to |VQ1−VQ2|. Compared with the i1-th time for the i2-th time, an absolute value of a compensation value ΔVDATA of the data signal VDATA can be positively correlated with ΔVth. Taking into account impact of detection accuracy and other effects, an absolute value of ΔVDATA can be equal to k1×|ΔVth|, wherein k1 is greater than 0.

It should be noted that in order to improve consistency of a detection standard, VQ can be measured at the time when VQ is relatively stable in the threshold voltage external detection period t1 after the i1-th power-on and the i2-th power-on.

Second, in a light-emitting external detection period t2, as shown in FIG. 7 and FIG. 8, the first writing control signal WR1 and the second light-emitting control signal EM2 are both at corresponding high potentials to control the internal compensation transistor T2 and the reset transistor T6 to turn off. The second writing control signal WR2, the first light-emitting control signal EM1, and the reading and writing control signal RD are all at corresponding low levels to control the reset transistor T6, the light-emitting control transistor T5, and the external compensation transistor T4 to all turn on. The corresponding ΔVDATA can be determined after the threshold voltage external detection period t1 and the power-on (the second and subsequent times). In order to avoid the impact of the shift in the threshold voltage of the driving transistor T1 on the luminous brightness of the light-emitting element. At this time, new data voltage “VDATA+ΔVDATA” can be superimposed on a basis of a theoretical data voltage and loaded to the source of the data writing transistor T3, so as to be transmitted to the first node N through the data writing transistor T3 and so that the change amount of the potential VN of the first node N is “(VDATA+ΔVDATA)−VREF”. Due to coupling effect of the storage capacitor Cs, the potential of the second node Q also has the same amount of change, so that the potential of the second node Q “ELVDD−|Vth2|+(VDATA+ΔVDATA)−VREF” is also consistent with the new data voltage. At this time, the driving transistor T1 is also turned on, which can be considered to be working in the saturation region, and the light-emitting control transistor T5 is turned on so that the new driving current (related to the new data voltage) generated by the driving transistor T1 flows into the light-emitting element. At this time, the potential of the third node B can be detected through the external compensation module.

Specifically, it can be understood herein that the pixel driving circuit 101 has the light-emitting external detection period t2 located after the threshold voltage external detection period t1 before the first frame. During the light-emitting external detection period t2, combined with the above-mentioned discussion, the first writing control signal WR1 and the second writing control signal WR2 are different, and the first light-emitting control signal EM1 and the second light-emitting control signal EM2 is different. Specifically, the data writing transistor T3 is used for responding to the second writing control signal WR2 to transmit the target data signal VDATA (that is, “VDATA+ΔVDATA”) to the storage capacitor Cs to turn on the driving transistor T1. The light-emitting control transistor T5 is used for responding to the first light-emitting control signal EM1 to electrically connect the light-emitting element and the driving transistor T1. The external compensation transistor T4 is used for responding to the reading and writing control signal RD to read the electrical signal of the light-emitting element (that is, the potential of the third node B). The target data signal VDATA is determined based on the data signal VDATA and the threshold voltage. The internal compensation transistor T2 is used for responding to the first writing control signal WR1 to electrically disconnect the gate of the driving transistor T1 and the output terminal of the driving transistor T1. The reset transistor T6 is used for responding to the second light-emitting control signal EM2 to electrically disconnect from the storage capacitor Cs.

During the period, turning off the reset transistor T6 can prevent the first signal VREF from being transmitted to the first node N and affecting its potential, and turning off the internal compensation transistor T2 can prevent the potential of the second node Q from affecting the potential of the third node B.

It can be seen that a second writing control pulse p3 in the second writing control signal WR2 is staggered to set up with a second light-emitting control pulse p4 close to the corresponding second writing control pulse p3 in the second light-emitting control signal EM2. For example, as shown in FIG. 5, the second light-emitting control pulse p4 covers the threshold voltage external detection period t1, but the second writing control pulse p3 is not set within the threshold voltage external detection period t1. For example, as shown in FIG. 8, the second writing control pulse p3 covers the light-emitting external detection period t2, but the second light-emitting control pulse p4 is not set in the light-emitting external detection period t2. Alternatively, for example, as shown in FIG. 9, the second light-emitting control pulse p4 covers the light-emitting external detection period t2, and the second writing control pulse p3 is not set in the light-emitting external detection period t2.

Specifically, in the present embodiment, the light-emitting external detection period t2 after a j1-th time (j1 is a positive integer) can be detected (before which there must be the corresponding threshold voltage external detection period t1) through the above-mentioned method. To obtain the j1-th VB (called VB1, which is close to the anode potential of the light-emitting element when it emits light for the j1-th time). In a j2-th time (j2 is a positive integer greater than j1), the j2-th VB (called VB2, which is close to the anode potential when the light-emitting element emits light for the j2-th time). Both j1 and j1 can be the same or different, and j2 and j2 can be the same or different. That is, there must be the corresponding threshold voltage external detection period t1 before the light-emitting external detection period t2 in the present embodiment, but not every threshold voltage external detection period t1 has the corresponding light-emitting external detection period t2 after it. That is, a frequency of a light-emitting external detection can be smaller than a frequency of a threshold voltage external detection. Then, compared with the j1-th startup, the absolute value of the change in the anode potential of the light-emitting element when it emits light under the same “VDATA+ΔVDATA” can be positively correlated with the absolute value of the VB offset ΔVB. If other factors are not considered, they can be considered equal.

It should be noted that due to a leakage current of the internal compensation transistor T2, the brightness of the light-emitting element continues to decrease when the external compensation module detects the potential of the third node B, and the detected potential of the third node B continues to decline. Based on this, the internal compensation transistor T2 can be configured to include two transistors connected in series. Gates of the two transistors are short-circuited to serve as a gate of the internal compensation transistor T2. A drain of the one transistor is connected to the second node Q, and a source of the other transistor is connected to the third node B. Similarly, in order to improve the consistency of the detection standard, VB can be measured at the time corresponding to the same degree of VB leakage in the light-emitting external detection period t2 after the j1-th power-on and the j2-th power-on.

Certainly, in other embodiments, as shown in FIG. 9 and FIG. 10, the pixel driving circuit 101 can further have the light-emitting external detection period t2 before the first frame (the above-mentioned threshold voltage cannot be set before it). During the light-emitting external detection period, the first writing control signal WR1 is different from the second writing control signal WR2, and the first light-emitting control signal EM1 is different from the second light-emitting control signal EM2. Specifically, the data writing transistor T3 is used for responding to the second writing control signal WR2 to transmit the third signal VGMP to the one end of the storage capacitor Cs (that is, the first node N) to turn off the driving transistor T1. The external compensation transistor T4 is used for transmitting the fourth signal VMON to the light-emitting control transistor T5 in response to the reading and writing control signal RD. The light-emitting control transistor T5 is used for responding to the first light-emitting control signal EM1 to electrically connect the light-emitting element and the driving transistor T1, so that the fourth signal VMON is transmitted to the light-emitting element. The external compensation transistor T4 is further used for responding to the reading and writing control signal RD to read the threshold voltage of the light-emitting element and to compensate the threshold voltage of the driving transistor T1. The internal compensation transistor T2 is used for responding to the first writing control signal WR1 to electrically disconnect the gate of the driving transistor T1 and the output terminal of the driving transistor T1. The reset transistor T6 is used for responding to the second light-emitting control signal EM2 to electrically disconnect from the storage capacitor Cs.

A difference between the present embodiment and the light-emitting external detection period t2 in the previous embodiment is that herein the third signal VGMP of the high potential instead of the data signal VDATA is transmitted to the first node N through the turned-on data writing transistor T3. Analyzing in the same way, the change amount of the potential VN of the first node N at this time is “VGMP−VREF”. Due to the coupling effect of the storage capacitor Cs, the potential of the second node Q also changes by the same amount, so that the potential of the second node Q is higher at this time. This causes the driving transistor T1 to turn off and makes the driving current close to 0. At this time, the external detection module can transmit the fourth signal VMON to the anode of the light-emitting element through the turned-on external compensation transistor T4 and the light-emitting control transistor T5. This can be considered that the potential of the fourth signal VMON is still higher than the ground voltage ELVSS, so that the light-emitting element is still turned on and the external detection module can still measure the anode potential of the light-emitting element when it emits light.

In the present embodiment, turning off the reset transistor T6 can prevent the first signal VREF from being transmitted to the first node N and affecting its potential, and turning off the internal compensation transistor T2 can prevent the potential of the second node Q from affecting the potential of the third node B.

In the present embodiment, the change in the anode potential of the light-emitting element when the light-emitting element emits light under the action of the same fourth signal VMON can be referred to the change in the anode potential of the light-emitting element in the previous embodiment when the light-emitting element emits light under the action of the same “VDATA+ΔVDATA” of measuring the absolute value of a quantity.

It can be seen that a first light-emitting control pulse p5 in the first light-emitting control signal EM1 is overlapped with the reading and writing control pulse p2 in the reading and writing control signal RD. It is staggered to set up to be close and corresponding to the first writing control pulse p1 in the first light-emitting control pulse p5 in the first reading control signal WR1. For example, as shown in FIG. 8 and FIG. 10, the first light-emitting control pulse p5 and the reading and writing control pulse p2 both cover the light-emitting external detection period t2, but the first writing control pulse p1 is not set in the light-emitting external detection period t2.

It should be noted that the pixel driving circuits 101 located in the same row can be controlled by the same reading and writing control signal RD. Each reading and writing control signal RD can control the opening and closing of multiple corresponding external compensation transistors T4, which is positively related to the row scanning period. At this time, the above-mentioned threshold voltage external detection period t1 and light-emitting external detection period t2 are also set before multiple frames (not the first frame). In order to improve the detection accuracy of the external detection module in at least one of the above-mentioned threshold voltage external detection period t1 and the light-emitting external detection period t2, the period of the reading and writing control signal RD can be set longer. This can be achieved by reducing frequency.

Third, in a first reset period t3 (including a first sub-period S0-1 and a second sub-period S0-2), as shown in FIG. 11 and FIG. 12, during the first sub-period S0-1, the second light-emitting control signal EM2, the first writing control signal WR1, and the reading and writing control signal RD are all at corresponding high potentials to control turn-off of the reset transistor T6, the internal compensation transistor T2, and the external compensation transistor T4. The first light-emitting control signal EM1 and the second writing control signal WR2 are at corresponding low potentials to control turn-off of the internal compensation transistor T2 and the data writing transistor T3. For the convenience of description, the discussion herein is based on the embodiment shown in FIG. 7. At this time, the third signal VGMP is transmitted to the first node N through the data writing transistor T3. At this time, the change amount of the potential VN of the first node N is “VGMP−(VDATA+ΔVDATA)”. Due to the coupling effect of the storage capacitor Cs, the potential of the second node Q also changes by the same amount, making the potential of the second node Q become “ELVDD−|Vth2|+(VDATA+ΔVDATA)−VREF+VGMP−(VDATA+ΔVDATA)”, that is, “ELVDD−|Vth2|−VREF+VGMP”. The second signal ELVDD and the third signal VGMP are at high potential, so the potential of the gate of the driving transistor T1 can be considered to be close to the dark state voltage and the driving transistor T1 is close to the off state. At this time, there is a very small dark state current flowing through the light-emitting element.

In the second sub-period S0-2, as shown in FIG. 13 and FIG. 12, the second light-emitting control signal EM2, the first writing control signal WR1, and the second writing control signal WR2 are all corresponding high potentials to control the reset transistor T6, the internal compensation transistor T2, and the data writing transistor T3 to turn off. The first light-emitting control signal EM1 and the reading and writing control signal RD are both at corresponding low potentials to control the internal compensation transistor T2 and the external compensation transistor T4 to turn on. At this time, the first node N and the second node Q can respectively maintain their previous potentials. The driving transistor T1 is still turned off, and the fourth signal VMON The driving transistor T1 is still turned off, and the fourth signal VMON with a low potential is transmitted to the anode of the light-emitting element (i.e., the fourth node C) through the turned-on external compensation transistor T4 and the light-emitting control transistor T5 to reset the changed potential.

As shown in FIG. 11 and FIG. 12, it can be understood that the pixel driving circuit 101 has the above-mentioned first reset period t3 in each frame. The first sub-period S0-1 in the first reset period t3 is specifically expressed as follows. The data writing transistor T3 is used for transmitting the third signal VGMP to the one end of the storage capacitor Cs in response to the second writing control signal WR2. The reset transistor T6 is used for responding to the second light-emitting control signal EM2 to transmit the first signal VREF to the one end of the storage capacitor Cs to realize at least one of two functions to turn off the driving transistor T1. The internal compensation transistor T2 is used for responding to the first writing control signal WR1 to electrically disconnect the gate of the driving transistor T1 and the output terminal of the driving transistor T1.

At this stage, the third signal VGMP with a high potential is applied to the driving transistor T1 to control it to turn off, thereby avoiding the generation of a large driving current. The internal compensation transistor T2 disconnects the gate and drain of the driving transistor T1 to prevent the potential of the third node B and the fourth node C from being affected by the potential of the second node Q. As mentioned above, the reset transistor T6 can also be turned on to transmit the first signal VREF with a high potential to the first node N in an embodiment different from FIG. 11. That is, at least one of the data writing transistor T3 and the reset transistor T6 is turned on, and both can raise the second node Q to a higher potential to turn off the driving transistor T1.

In the first sub-period S0-1, FIG. 13, FIG. 12, the second sub-period S0-2 in the first reset period t3, the first reset period, the first light-emitting control signal EM1 is different from the first writing control signal WR1. Specifically, the external compensation transistor T4 is used for responding to the reading and writing control signal RD to transmit the fourth signal VMON to the light-emitting control transistor T5. The light-emitting control transistor T5 is used for responding to the first light-emitting control signal EM1 to transmit the second signal ELVDD to the light-emitting element to reset the light-emitting element. The internal compensation transistor T2 is used for responding to the first write control signal WR1 to electrically disconnect the gate of the driving transistor T1 and the output terminal of the driving transistor T1.

This stage is to reset the low-potential fourth signal VMON by transmitting it to the fourth node C (i.e., the anode of the light-emitting element). In the same way, the data writing transistor T3, the reset transistor T6, and the internal compensation transistor T2 are all turned off to avoid affecting the reset of the potential of the fourth node C.

It can be seen that the second writing control pulse p3 in the second writing control signal WR2 is staggered with the reading and writing control pulse p2 close to the corresponding second writing control pulse p3 in the reading and writing control signal RD, and the second writing control pulse p3 is located before the corresponding reading and writing control pulse p2. For example, as shown in FIG. 12, the second writing control pulse p3 is located in the first sub-period S0-1 in the first reset period t3, and the reading and writing control pulse p2 is located in the first sub-period S0-1 in the corresponding first reset period t3.

Furthermore, the first light-emitting control pulse p5 in the first light-emitting control signal EM1 overlaps with the second writing control pulse p3 in the second writing control signal WR2. The starting point of the first light-emitting control pulse p5 is earlier than or equal to the starting point of the corresponding second writing control pulse p3, and the end point of the first light-emitting control pulse p5 is later than the corresponding end point of the second writing control valid pulse. For example, as shown in FIG. 12, the second writing control pulse p3 is located in the first sub-period S0-1 of the first reset period t3, and the first light-emitting control pulse p5 covers the entire first reset period t3.

Fourth, in a second reset period S0-3, as shown in FIG. 14 and FIG. 12, the first light-emitting control signal EM1 and the second writing control signal WR2 are both at corresponding high potentials to control the light-emitting control transistor T5 and the data writing transistor T3 to turn off. The second light-emitting control signal EM2, the first writing control signal WR1, and the reading and writing control signal RD all have corresponding low potentials to control the reset transistor T6, the internal compensation transistor T2, and the external compensation transistor T4 to turn on. At this time, the fourth signal VMON, which is at a low potential, is transmitted to the second node Q through the turned-on external compensation transistor T4 and the internal compensation transistor T2, and the driving transistor T1 is turned on. At the same time, the first signal VREF with a high potential is transmitted to the first node N through the turned-on reset transistor T6 to maintain the potential of the first terminal of the storage capacitor Cs. This is beneficial to the charging of the storage capacitor Cs. This allows the potential of the second terminal (second node Q) of the storage capacitor Cs to be charged to achieve stability, thereby achieving reset.

It can be understood herein that the pixel driving circuit 101 has the above-mentioned second reset period S0-3 in each frame (which can be located after the corresponding first reset period t3). During the second reset period S0-3, the first light-emitting control signal EM1 is different from the first writing control signal WR1. During the second reset period S0-3, the reset transistor T6 is used for responding to the second light-emitting control signal EM2 to transmit the first signal VREF to the one end of the storage capacitor Cs (in FIG. 14, this is just an example). The data writing transistor T3 is used for responding to the second writing control signal WR2 to transmit the third signal VGMP to the one end of the storage capacitor Cs (not shown in FIG. 14) to implement at least one of two functions. The external compensation transistor T4 is used for responding to the reading and writing control signal RD to transmit the fourth signal VMON to the source of the driving transistor T1. The internal compensation transistor T2 is used for responding to the first writing control signal WR1 and electrically connecting the gate of the driving transistor T1 and the source of the driving transistor T1, so that the fourth signal VMON is transmitted to the gate of the driving transistor T1 to reset the driving transistor T1. The light-emitting control transistor T5 is used for responding to the first light-emitting control signal EM1 to electrically disconnect from the driving transistor. T1.

At this stage, the fourth signal VMON is transmitted to the second node Q to reset it, and one of the reset transistor T6 and the data writing transistor T3 needs to be turned on to maintain the potential of the first node N. This is beneficial to reset the potential of the second node Q.

In particular, the third signal VGMP discussed throughout the present disclosure can be understood as another signal independent of the data signal VDATA. It can also be understood as part of the signal belonging to the first signal VREF. That is, the source of the data writing transistor T3 can always be loaded with the first signal VREF. As shown in FIG. 3 and FIG. 12, the first signal VREF is equal to the third signal VGMP in the corresponding period. It can be seen from the above-mentioned circuit diagram of S0-1, S0-2, and S0-3 and the timing diagram in FIG. 12. Since the sources of the data transistors in S0-1 and S0-2 need to be loaded with the third signal VGMP, the first signal VREF can be set to a value equal to the third signal VGMP in S0-1 and S0-2. In S0-3, the data writing transistor T3 can be turned off, so the specific value of the first signal VREF is not limited. For example, at this time, it can be equal to the value of the first signal VREF. Based on the above-mentioned discussion, in t1, the first signal VREF can be set to be equal to the third signal VGMP or to be a valid data signal.

Fifth, in a threshold voltage internal detection period S1, as shown in FIG. 15 and FIG. 12, the first light-emitting control signal EM1, the second writing control signal WR2, and the reading and writing control signal RD are all at corresponding high potentials to control the light-emitting control transistor T5, the data writing transistor T3, and the external compensation transistor T4 to turn off. The second light-emitting control signal EM2 and the first writing control signal WR1 are both at corresponding low potentials to control the reset transistor T6 and the internal compensation transistor T2 to turn on. At this time, the first signal VREF, which is at a high potential, is transmitted to the first node N through the turned-on reset transistor T6. The driving transistor T1 remains to turn on. The second signal ELVDD with a high potential charges the second node Q through the driving transistor T1 and the turned-on internal compensation transistor T2. When the potential VQ of the second node Q gradually rises to a point where the difference between it and the potential of the source of the driving transistor T1 (equal to ELVDD) is equal to the third threshold voltage Vth3 (which may be equal to Vth2) of the driving transistor T1 at this time, that is, “VQ−ELVDD=Vth3”, the driving transistor T1 is turned off. Therefore, the potential VQ of the second node Q gradually approaches ELVDD+Vth3 (Vth3<0).

Different from T1, S1 only saves the third threshold voltage Vth3 of the driving transistor T1 at the second node Q and does not turn on the external compensation transistor T4 to detect it. Each frame can include the above-mentioned S0-1, S0-2, and S0-3. S1 can be performed after S0-3 of each frame to “detect” the threshold voltage of the driving transistor T1 in this frame.

It can be seen from above-mentioned that the second light-emitting control pulse p4 in the second light-emitting control signal EM2 overlaps with the first writing control pulse p1 in the first writing control signal WR1. For example, as shown in FIG. 12, the second light-emitting control pulse p4 and the first writing control pulse p1 both cover the threshold voltage internal detection period S1.

Sixth, in a data writing period S2, as shown in FIG. 16 and FIG. 12, the first light-emitting control signal EM1, the second light-emitting control signal EM2, the first writing control signal WR1, and the reading and writing control signal RD are all at corresponding high potentials to control the light-emitting control transistor T5, the reset transistor T6, the internal compensation transistor T2, and the external compensation transistors T4 to turn off. The low potential corresponding to the second write control signal WR2 controls the data writing transistor T3 to turn on. The data signal VDATA, which is at a low potential at this time (the valid data signal VDATA at this time), is transmitted to the first node N through the turned-on data writing transistor T3, so that the change amount of the potential VN of the first node N is “VDATA−VREF”. Due to the coupling effect of the storage capacitor Cs, the potential of the second node Q also has the same amount of change, so the potential VQ of the second node Q is “ELVDD−|Vth3|+VDATA−VREF”. It can be seen that the potential of the second node Q includes the effective data signal VDATA in the data signal VDATA and the third threshold voltage of the driving transistor T1 at this time. The driving transistor T1 is turned on at this time. At this time, the driving transistor T1 is turned on.

Specifically, as mentioned above and during the data writing period S2, the first writing control signal WR1 is different from the second writing control signal WR2. Specifically, the data writing transistor T3 is used for responding to the second writing control signal WR2 to transmit the data signal VDATA to the one end of the storage capacitor Cs to turn on the driving transistor T1. The internal compensation transistor T2 is used for responding to the first writing control signal WR1 to electrically disconnect the gate of the driving transistor T1 and the drain of the driving transistor T1. This prevents the high-potential second signal ELVDD from charging the second node Q through the driving transistor T1 and the internal transistor, causing the potential of the second node Q to be unable to hold the data signal VDATA and the third threshold voltage of the driving transistor T1 at this time.

It can be seen that the second writing control pulse p3 in the second writing control signal WR2 is interleaved with the first writing control pulse p1 close to the corresponding second writing control pulse p3 in the first writing control signal0 WR1. The first writing control pulse p1 is located before the corresponding second writing control pulse p3. For example, as shown in FIG. 12, the second writing control pulse p3 can be located in the data writing period S2, but the first writing control pulse p1 is not set in the data writing period S2.

Seventh, as shown in FIG. 17 and FIG. 12, the second light-emitting control signal EM2, the first writing control signal WR1, the reading and writing control signal RD, and the second writing control signal WR2 are all at corresponding high potentials to control the reset transistor T6, the internal compensation transistor T2, the external compensation transistor T4, and the data writing transistor T3 to turn off. The first light-emitting control signal EM1 is a corresponding low potential to control the light emitting control transistor T5 to turn on. At this time, the storage capacitor Cs maintains the potential of the first node N and the second node Q at both ends unchanged. The driving current generated by turning on the driving transistor T1 is transmitted to the light-emitting element through the turned-on light-emitting control transistor T5, and the light-emitting element emits light.

In the embodiment shown in FIG. 17, the potential VQ of the second node Q is maintained at “ELVDD−|Vth3|+VDATA−VREF”, so the voltage difference between the gate and the source of the driving transistor T1 is “VQ−ELVDD”. The driving current is equal to k2×((VQ−ELVDD)−Vth3)2. After substituting into the expression of VQ, the driving current is equal to k2×(VDATA−VREF)2. Therefore, through the above-mentioned S1 and S2, the compensation for the threshold voltage of the driving transistor T1 in this frame is realized through internal compensation.

It can be seen from the above-mentioned that the first light-emitting control pulse p5 in the first light-emitting control signal EM1 is staggered with the first writing control pulse p1 close to the corresponding first light-emitting control pulse p5 in the first write control signal WR1. The reading and writing control pulse p2 that is close to the corresponding first light-emitting control pulse p5 in the read-write control signal RD is staggered to set up. The first light-emitting control pulse p5 is located after the corresponding first writing control pulse p1 and the corresponding reading and writing control pulse p2. For example, as shown in FIG. 12, the first light-emitting control pulse p5 covers the light-emitting period S3. The first writing control pulse p1 and the reading and writing control pulse p2 are not set in the light-emitting period S3, and the first writing control pulse p1 and the reading and writing control pulse p2 are all located before the light-emitting period S3.

Certainly, in the embodiment shown in FIG. 18, what is different from the timing diagram of S3 shown in FIG. 12 is that the second light-emitting control potential at this time can also be a corresponding low potential to turn on the reset transistor T6. At this time, the first signal VREF is transmitted to the first node N. That is, VN in S3 is equal to VREF. The VN in S2 is “VREF+(VDATA−VREF)”, which is equal to VDATA. Therefore, the change in the potential of the first node N in S3 is “VREF−VDATA”. Correspondingly, the potential of the second node Q also has the same amount of change, but in this case it needs to be considered that VQ in S1 gradually approaches “ELVDD+Vth3” but does not be equal to. It can be considered that VQ in S1 is equal to a×(ELVDD+Vth3), wherein 0<a<1. In S2, all capacitances CN coupling the first node N to other signals and all capacitances CQ coupling the second node Q to other signals need to be considered. Therefore, there is an equation of “ΔVN×CN=ΔVQ×CQ”. VQ in S2 is equal to “(CN/CQ)×(VDATA−VREF)+a×(ELVDD+Vth3)”. It assumes that “CN/CQ” is equal to b. VQ in S2 is equal to a×(ELVDD+Vth3)+b×(VDATA−VREF). VQ in S3 is equal to the sum of VQ in S2 and “VREF−VDATA”. That is, it is equal to a×(ELVDD+Vth3)+(b−1)×(VDATA−VREF). The driving current is equal to k2×((VQ−ELVDD)−Vth3)2. After substituting into the expression of VQ, the driving current is equal to k2×((a−1)×(ELVDD+Vth3)+(b−1)×(VDATA−VREF))2.

Certainly, different from the embodiment shown in FIG. 17 and FIG. 18 and different from the timing diagram of S3 shown in FIG. 12, the potential of the second writing control signal at this time can also be a corresponding low potential to turn on the data writing transistor T3 to still write VDATA like the first node N. Since the potential of the first node N in S3 is the same as the potential of the first node N in S2, the potential VQ of the second node Q is maintained at “ELVDD−|Vth3|+VDATA-VREF” in the same as the above-mentioned embodiment shown in FIG. 17. The driving current is also equal to k2×(VDATA−VREF)2.

It should be noted that if an external threshold voltage detection period t1 is performed before the first frame after this or at least one previous boot to determine the compensation value ΔVDATA of the data signal VDATA. The data signal VDATA loaded during the data writing period S2 can be the new data signal VDATA after superimposing ΔVDATA. That is, the change of VN in S2 can be “VDATA+ΔVDATA−VREF”. VQ is “ELVDD−|Vth3|+VDATA+ΔVDATA−REF”. Correspondingly, the driving current in S3 is equal to k2×(VDATA+ΔVDATA−VREF)2.

Accordingly, in the present disclosure, the threshold voltage external detection period t1 can be set after two intervals of power-on to obtain the ΔVth of the driving transistor T1 at the last power-on, so as to obtain the compensation value ΔVDATA1 corresponding to the data voltage displayed on the entire screen after the last boot. Therefore, during the data writing period S2 of each frame, the driving transistor T1 is turned on according to the voltage related to the ΔVDATA1 to achieve external compensation of the threshold voltage. At the same time, in the threshold voltage internal detection period S1, the data writing period S2, and the light-emitting period S3 of each frame, the internal compensation of the threshold voltage can be achieved through the above-mentioned timing settings.

Similarly, the present disclosure can also set the light-emitting external detection period t2 after two intervals of power-on to obtain the potential offset of the anode of the ΔVth of the light-emitting element at the last time of power-on. The compensation value ΔVDATA2 corresponding to the data voltage displayed on the entire screen after the last boot can also be obtained according to the corresponding algorithm. Therefore, during the data writing period S2 of each frame, the driving transistor T1 is turned on according to the voltage related to ΔVDATA2 to achieve external compensation of the light-emitting element. At the same time, in the threshold voltage internal detection period S1, the data writing period S2, and the light-emitting period S3 of each frame, the internal compensation of the threshold voltage can be achieved through the above timing settings.

The light-emitting external detection period t2 can be set corresponding to the threshold voltage external detection period t1. It can also be to set only the light-emitting external detection period t2 or only the threshold voltage external detection period t1. Please refer to the above-mentioned discussion for details.

The present disclosure provides the pixel driving circuit and the display panel based on the light-emitting element, the driving transistor for generating the driving current according to the data signal to drive the light-emitting element to emit light, the storage capacitor for storing the data signal, the internal compensation transistor for responding to the first writing control signal to compensate the threshold voltage of the driving transistor, and the external compensation transistor for reading the electrical signal from the source of the drive transistor in response to the reading and writing control signal and compensating the threshold voltage of the driving transistor (electrically connected to the source of the light-emitting control transistor and the driving transistor). The first writing control signal is set to be different from the second writing control signal, so that in the data writing period of each frame, the data signal is transmitted to one end of the storage capacitor to turn on the driving transistor. The gate and the drain of the driving transistor are electrically disconnected, thereby improving the reliability of data signal writing and the accuracy of driving current.

Although the principles and implementations of the present disclosure are described by using specific examples in this specification, the above-mentioned descriptions of the embodiments are only intended to help understand the method and the core idea of the method of the present disclosure. Moreover, those skilled in the art can make modifications to the specific implementations and an application range according to the idea of the present disclosure. In conclusion, the content of the specification is not intended to be construed as a limitation on the present disclosure.

1. A pixel driving circuit, comprising:
a light-emitting element;
a driving transistor for generating a driving current according to a data signal to drive the light-emitting element to emit light;
a data writing transistor for transmitting the data signal to the driving transistor in response to a second write control signal;
a storage capacitor electrically connected to the driving transistor for storing the data signal;
an internal compensation transistor electrically connected between a gate of the driving transistor and a drain of the driving transistor for compensating a threshold voltage of the driving transistor in response to a first writing control signal, wherein the first writing control signal is different from the second writing control signal; and
an external compensation transistor, wherein the external compensation transistor is electrically connected to the light-emitting control transistor and a source of the driving transistor, and the external compensation transistor is used for responding to a reading and writing control signal to read an electrical signal of the source of the driving transistor and to compensate the threshold voltage of the driving transistor.

2. The pixel driving circuit of claim 1, further comprising:
a light-emitting control transistor electrically connected between the light-emitting element and the driving transistor for responding to a first light-emitting control signal to transmit the driving current to the light-emitting element; and
a reset transistor electrically connected to the storage capacitor and the data writing transistor used for responding to a second light-emitting control signal to transmit a first signal to one end of the storage capacitor, wherein the first signal is different from a second signal loaded on the source of the driving transistor.

3. The pixel driving circuit of claim 2, wherein the pixel driving circuit has a data writing period in each frame, and during the data writing period, the first writing control signal is different from the second writing control signal; and
during the data writing period, the data writing transistor is used for responding to the second writing control signal to transmit the data signal to the one end of the storage capacitor to turn on the driving transistor, the compensation transistor is used for responding to the first writing control signal to electrically disconnect the gate of the driving transistor and the drain of the driving transistor.

4. The pixel driving circuit of claim 3, wherein the pixel driving circuit has a light-emitting period in each frame, and during the light-emitting period, the first light-emitting control signal is different from the second light-emitting control signal, and the first writing control signal is the same as the second writing control signal; and
during the light-emitting period, the reset transistor is used for responding to the second light-emitting control signal, the data writing transistor is used for responding to the second writing control signal to jointly maintain a voltage at the one end of the storage capacitor to be a voltage corresponding to the data signal, the internal compensation transistor is used for responding to the first writing control signal to maintain a voltage at the other end of the storage capacitor to be a voltage during the data writing period to maintain turning on the driving transistor, and the light-emitting control transistor is used for responding to the first light-emitting control signal to electrically connect the light-emitting element and the driving transistor to transmit the driving current to the light-emitting element.

5. The pixel driving circuit of claim 2, wherein the pixel driving circuit has a first reset period in each frame, and during the first reset period, the first writing control signal is different from the second write control signal; and
during the first reset period, the data write transistor is used for responding to the second writing control signal to transmit a third signal to the one end of the storage capacitor, the reset transistor is used for responding to the second light-emitting control signal to transmit the first signal to the one end of the storage capacitor to realize at least one of two functions to turn off the driving transistor, and the internal compensation transistor is used for responding to the first writing control signal to electrically disconnect the gate of the driving transistor and an output terminal of the driving transistor.

6. The pixel driving circuit of claim 5, wherein during the first reset period, the first light-emitting control signal is different from the first writing control signal; and
during the first reset period, the external compensation transistor is used for responding to the reading and writing control signal to transmit a fourth signal to the light-emitting control transistor, the light-emitting control transistor is used for responding to the first light-emitting control signal to transmit the second signal to the light-emitting element to reset the light-emitting element, and the internal compensation transistor is used for responding to the first writing control signal to electrically disconnect the gate of the driving transistor and the output terminal of the driving transistor.

7. The pixel driving circuit of claim 2, wherein the pixel driving circuit has a second reset period in each frame, and during the second reset period, the first light-emitting control signal is different from the first writing control signal;
during the second reset period, the reset transistor is used for transmitting the first signal to the one end of the storage capacitor in response to the second light-emitting control signal, the data writing transistor is used for responding to the second writing control signal to transmit a third signal to the one end of the storage capacitor to implement at least one of two functions, the external compensation transistor is used for responding to the reading and writing control signal to transmit a fourth signal to the source of the driving transistor, and the internal compensation transistor is used for electrically connect the gate of the driving transistor and the source of the driving transistor in response to the first writing control signal, so that the fourth signal is transmitted to the gate of the driving transistor to reset the driving transistor; and
wherein the light-emitting control transistor is used for responding to the first light-emitting control signal to electrically disconnect from the driving transistor.

8. The pixel driving circuit of claim 2, wherein the pixel driving circuit has a threshold voltage external detection period before a first frame, and during the threshold voltage external detection period, the first light-emitting control signal is different from the first writing control signal;
during the threshold voltage external detection period, the reset transistor is used for responding to the second light-emitting control signal to transmit the first signal to the one end of the storage capacitor; the data writing transistor is used for responding to the second writing control signal to transmit a third signal to the one end of the storage capacitor to implement at least one of two functions, the internal compensation transistor is used for transmitting the second signal to the one end of the storage capacitor in response to the first writing control signal, and the external compensation transistor is used for read the threshold voltage of the driving transistor in response to the reading and writing control signal;
wherein the light-emitting control transistor is used for responding to the first light-emitting control signal to electrically disconnect from the driving transistor.

9. The pixel driving circuit of claim 8, wherein the pixel driving circuit has a light-emitting external detection period located after the threshold voltage external detection period before the first frame, and during the light-emitting external detection period, the first writing control signal is different from the second writing control signal, and the first light-emitting control signal is different from the second light-emitting control signal;
during the light-emitting external detection period, the data writing transistor is used for responding to the second writing control signal to transmit a target data signal to the storage capacitor to turn on the driving transistor, the light-emitting control transistor is used for responding to the first light-emitting control signal to electrically connect the light-emitting element and the driving transistor, the external compensation transistor is used for reading an electrical signal of the light-emitting element in response to the reading and writing control signal; and
wherein the internal compensation transistor is used for responding to the first writing control signal to electrically disconnect the gate of the driving transistor and an output terminal of the driving transistor, and the reset transistor is used for responding to the second light-emitting control signal to electrically disconnect from the storage capacitor.

10. The pixel driving circuit of claim 2, wherein the pixel driving circuit has a light-emitting external detection period before a first frame, and during the light-emitting external detection period, the first writing control signal and the second writing control signal are different, and the first light-emitting control signal is different from the second light-emitting control signal;
during the light-emitting external detection period, the data writing transistor is used for responding to the second writing control signal to transmit a third signal to the one end of the storage capacitor to turn off the driving transistor, the external compensation transistor is used for transmitting a fourth signal to the light-emitting control transistor in response to the reading and writing control signal, the light-emitting control transistor is used for responding to the first light-emitting control signal to electrically connect the light-emitting element and the driving transistor, so that the fourth signal is transmitted to the light-emitting element, and the external compensation transistor is further used for reading a threshold voltage of the light-emitting element in response to the reading and writing control signal and to compensate the threshold voltage of the driving transistor;
wherein the internal compensation transistor is used for responding to the first writing control signal to electrically disconnect the gate of the driving transistor and an output terminal of the driving transistor.

11. The pixel driving circuit of claim 2, wherein a first write control pulse of the first writing control signal is used for turning on the internal compensation transistor, and a reading and writing control pulse of the reading and writing control signal is used for turning on the external compensation transistor; and
wherein the first writing control pulse of the first writing control signal overlaps with the reading and writing control pulse of the reading and writing control signal, and a starting point of the first writing control pulse is earlier than a corresponding starting point of the reading and writing control pulse.

12. The pixel driving circuit of claim 2, wherein a second writing control pulse of the second writing control signal is used for turning on the data writing transistor, and a second light-emitting control pulse of the second light-emitting control signal is used for turning on the reset transistor; and
wherein the second writing control pulse of the second write control signal is staggered with the second light-emitting control pulse which is close to the corresponding second writing control pulse of the second light-emitting control signal.

13. The pixel driving circuit of claim 2, wherein a first light-emitting control pulse of the first light-emitting control signal is used for turning on the light-emitting control transistor, the reading and writing control pulse of the reading and writing control signal is used for turning on the external compensation transistor, and the first writing control pulse of the first writing control signal is used for turning on the internal compensation transistor; and
wherein the first light-emitting control pulse of the first light-emitting control signal overlaps with the reading and writing control pulse of the reading and writing control signal, and the first writing control pulse of the first writing control signal which is close to the corresponding first light-emitting control pulse is staggered.

14. The pixel driving circuit of claim 2, wherein a second writing control pulse of the second writing control signal is used for turning on the data writing transistor, and a reading and writing control pulse of the reading and writing control signal is used for turning on the external compensation transistor; and
wherein the second writing control pulse of the second writing control signal is staggered with the reading and writing control pulse which is close to the corresponding second writing control pulse of the reading and writing control signal.

15. The pixel driving circuit of claim 14, wherein a first light-emitting control pulse of the first light-emitting control signal is used for turning on the light-emitting control transistor; and
wherein the first light-emitting control pulse of the first light-emitting control signal overlaps with the second writing control pulse of the second writing control signal, a starting point of the first light-emitting control pulse is earlier than or equal to a starting point of the corresponding second writing control pulse, and an end point of the first light-emitting control pulse is later than an end point of the corresponding second writing control pulse.

16. The pixel driving circuit of claim 2, wherein a second light-emitting control pulse of the second light-emitting control signal is used for turning on the reset transistor; and
wherein a second light-emitting control pulse of the second light-emitting control signal is used for turning on the reset transistor, a first writing control pulse of the first writing control signal is used for turning on the internal compensation transistor, and a reading and writing control pulse of the reading and writing control signal is used for turning on the external compensation transistor; and
wherein the second light-emitting control pulse of the second light-emitting control signal overlaps with the first writing control pulse of the first writing control signal.

17. The pixel driving circuit of claim 2, wherein a second writing control pulse of the second writing control signal is used for turning on the data writing transistor, and a first writing control pulse of the first writing control signal is used for turning on the internal compensation transistor; and
wherein the second writing control pulse of the second writing control signal is interleaved with the first writing control pulse close to the corresponding second writing control pulse of the first writing control signal.

18. The pixel driving circuit of claim 2, wherein a first light-emitting control pulse of the first light-emitting control signal is used for turning on the light-emitting control transistor, a first writing control pulse of the first writing control signal is used for turning on the internal compensation transistor, and a reading and writing control pulse of the reading and writing control signals is used for turning on the external compensation transistor; and
wherein the first light-emitting control pulse of the first light-emitting control signal is staggered with the first writing control pulse which is close to the corresponding first light-emitting control pulse of the first writing control signal, the reading and writing control pulse which is close to the corresponding first light-emitting control pulse of the reading and writing control signal is staggered, and the first light-emitting control pulse is located after the corresponding first writing control pulse and the corresponding reading and writing control pulse.

19. A display panel, comprises:
a panel body comprising the pixel driving circuit; and
a driving chip electrically connected to the pixel driving circuit to drive the pixel driving circuit to work;
wherein pixel driving circuit, comprising:
a light-emitting element;
a driving transistor for generating a driving current according to a data signal to drive the light-emitting element to emit light;
a data writing transistor for transmitting the data signal to the driving transistor in response to a second write control signal;
a storage capacitor electrically connected to the driving transistor for storing the data signal;
an internal compensation transistor electrically connected between a gate of the driving transistor and a drain of the driving transistor for compensating a threshold voltage of the driving transistor in response to a first writing control signal, wherein the first writing control signal is different from the second writing control signal; and
an external compensation transistor, wherein the external compensation transistor is electrically connected to the light-emitting control transistor and a source of the driving transistor, and the external compensation transistor is used for responding to a reading and writing control signal to read an electrical signal of the source of the driving transistor and to compensate the threshold voltage of the driving transistor.

20. The display panel of claim 19, wherein the panel body further comprises multi-level gate driving circuits arranged in cascade; and
the driving chip comprises:
a timing controller, wherein each of the gate driving circuits is electrically connected between the timing controller and a corresponding one of plurality of pixel driving circuits for responding to a first control signal outputted by the timing controller to output the first light-emitting control signal, the second light-emitting control signal, the first writing control signal, or the second writing control signal; and
at least one source driver electrically connected between the timing controller and the corresponding plurality of pixel driving circuits for responding to a second control signal outputted by the timing controller to output the data signal.
